(19) United States
(12) Patent Application Publication
(10) Pub. No.: US 2021/0197787 A1
(43) Pub. Date: Jul. 1, 2021

(54) Method for Controlling an Electromechanical Brake Device in a Vehicle

(71) Applicant: Robert Bosch GmbH, Stuttgart (DE)

(72) Inventors: Frank Baehrle-Miller, Schoenaich (DE); Hubertus Wienken, Langenbrettach (DE); Burkhard Iske, Renningen (DE)

(21) Appl. No.: 17/057,657

(22) PCT Filed: May 24, 2019
(86) PCT No.: PCT/EP2019/063470

§ 371 Date: Nov. 21, 2020

(30) Foreign Application Priority Data
Jun. 22, 2018 (DE) 10 2018 210 232.5

(51) Int. Cl. B60T 17/22; B60T 13/74

(52) U.S. Cl. CPC B60T 17/221; F16D 2066/001; B60T 13/746; B60T 13/741

(57) ABSTRACT

A method for providing the clamping force generated by an electromechanical brake device in a vehicle includes setting the position of a brake piston as a function of a brake temperature when the vehicle is in motion.

The invention relates to a method for actuating an electromechanical brake device in a vehicle, by way of which electromechanical brake device a brake force can be generated with the aid of an electric brake motor that impinges a brake piston against a brake disk.

### PRIOR ART

A method for providing the clamping force generated by a holding brake in a vehicle is described in DE 10 2012 202 959 A1. The holding brake is embodied as an electromechanical brake device having an electric brake motor, a clamping force for immobilizing the vehicle when stopped being able to be generated by way of said electromechanical brake device. A rotating movement of the electric brake motor herein leads to an axial actuating movement of a brake piston which is a support of a brake lining. The brake piston presses the brake lining against a brake disk. The hydraulic pressure of the usual vehicle brake by way of which the vehicle in motion is decelerated moreover acts on the brake piston.

In the method described in DE 10 2012 202 959 A1, the electric brake motor is, following a first clamping procedure, activated again in order to carry out a post-clamping procedure, wherein the post-clamping procedure is carried out as a function of the brake disk temperature.

### DISCLOSURE OF THE INVENTION

The method according to the invention relates to the actuation of an electromechanical brake device in a vehicle, wherein the electromechanical brake device comprises an electric brake motor which, in order to generate a brake force, impinges a brake piston having a brake lining against a brake disk.

The electromechanical brake device can be integrated in a wheel brake installation which is also part of the hydraulic vehicle brake. In this case, the brake piston is impinged by the brake pressure and pressed against the brake disk when the hydraulic vehicle brake is activated. The hydraulic vehicle brake and the electromechanical brake device form a common brake system.

The electromechanical brake device with the aid of the method according to the invention can be actuated before or while generating an electromechanical brake force. The method serves for adjusting the position of the brake piston to a desired position wherein the determination and adjustment of the position takes place as a function of the brake temperature. This enables the position of the brake piston to be adjusted as a function of temperature by correspondingly actuating the electric brake motor such that disadvantages that result from a variation in the temperature of the brake device are avoided. Variations in the length of the components of the electromechanical brake device due to temperature can in particular be compensated for.

The method relates to a vehicle in motion. Accordingly, the position of the brake piston is set as a function of the brake temperature when the vehicle is in motion. This enables a desired brake force to be provided by way of the electromechanical brake device within a short time if required, wherein negative influences due to temperature are compensated for. For example, a drop in temperature can lead to a contraction of the components of the brake device, and the displacement path of the brake piston which the latter has to travel until bearing on the brake disk may be increased. The time between the requirement and the action of the brake force can be shortened in that the position of the brake piston is correspondingly adjusted already when the vehicle is in motion.

Conversely, the position of the brake piston can also be adapted as a function of temperature in the case of an increase in temperature. For example, the brake piston can be retracted so as to maintain a minimum spacing from the brake disk and to avoid any unintentional grinding of the brake lining on the brake disk.

The method can be applied to situations in which the brake lining on the brake piston is spaced apart from the brake disk as well as to situations in which the brake lining bears on the brake disk and a brake force is being generated. The position of the brake piston can be adapted or corrected as a function of temperature in the latter case too, for example for maintaining a constant or an at least approximately constant brake force. Accordingly, the brake motor in the case of an increase in temperature is slightly adjusted in the releasing direction, for example, and in the case of a drop in temperature is slightly adjusted in the braking direction, so as to respectively decrease or increase the brake force.

The method relates exclusively to situations with a vehicle in motion. The vehicle assumes a minimum speed which is 3 km/h, for example, wherein a temperature compensation is carried out when in motion by way of the electromechanical brake device by adjusting the position of the brake piston. This approach enables a procedure of the vehicle entering or leaving a parking space to be carried out autonomously, for example, wherein the driver can optionally be outside the vehicle. It is ensured by virtue of the temperature compensation of the brake piston position that the brake force required for the autonomous procedure of entering or leaving the parking space can be provided to a sufficient extent and in the required time, and overheating of the brake installation is moreover avoided.

In principle, the method is also suitable for higher vehicle speeds than is required in a procedure of entering or leaving a parking space. A brake force for decelerating the vehicle can optionally also be generated by way of the electromechanical brake device at higher vehicle speeds. A temperature compensation in this case is also achieved by actuating the electric brake motor and adjusting the position of the brake piston as a function of temperature.

The situation of an increased brake temperature in the vehicle can arise in particular after a comparatively long drive and a frequent activation of the brake. With the aid of the method according to the invention, it is possible also in these situations for the desired temperature compensation to be achieved by way of the actuation of the brake motor and the brake piston.

The adjustment of the position of the brake piston can be carried out in a displacement-controlled or force-controlled manner. In those cases in which the brake piston, or the brake lining held on the brake piston, is spaced apart from the brake disk it is particularly expedient for a displacement-controlled actuation of the electric brake motor and the brake piston to be carried out. A nominal position for the brake piston, which is typically between a position of maximum retraction of the brake piston and the position of contact of the brake lining on the brake disk, is predefined herein. The nominal position to which the brake piston is adjusted is established as a function of temperature.

In the case of the brake piston, or the brake lining disposed on the brake piston, being in contact with the brake disk and a brake force being correspondingly generated, it can be advantageous for a force-controlled adjustment of the brake piston position to be carried out. Here, the brake piston position is adjusted as a function of the brake temperature in such a manner that the brake force advantageously remains at least approximately constant, irrespective of an increase or a drop in the brake temperature.

The brake temperature relates in particular to a component or a component part of the electromechanical brake device, for example to the brake disk temperature. The brake temperature can be determined either with the aid of a temperature sensor, or from a brake temperature model composed of known state variables or operating variables or characteristics of the brake device, of the vehicle, or another apparatus of the vehicle. For example, it is possible to resort to the temperature of a hydraulic medium in a hydraulic vehicle brake as the relevant brake temperature for the method according to the invention, or to derive the brake disk temperature from the temperature of the hydraulic medium. To the extent that the brake temperature is estimated from a brake temperature model, this optionally also takes place without the aid of a temperature sensor, for example based on the number of brake procedures within a defined period of time.

The invention furthermore relates to a closed-loop and/or open-loop control unit for actuating the adjustable components of the electromechanical brake device by way of which the method described above is carried out. The closed-loop and/or open-loop control unit can optionally be part of a brake system in the vehicle. Actuating signals for actuating the adjustable components of the brake device, in particular the electric brake motor, are generated in the closed-loop or open-loop control unit, respectively.

The invention moreover relates to an electromechanical brake device for a vehicle, which is advantageously used for immobilizing the vehicle when stopped, or else optionally can be used for decelerating the vehicle from comparatively high speeds. The electromechanical brake device, as described above, comprises an electric brake motor, a brake piston which is a support of a brake lining, as well as a brake disk against which the brake piston having the brake lining is adjusted, as well as a closed-loop and/or open-loop control unit as described above for actuating the adjustable components.

The electromechanical brake device, conjointly with a hydraulic vehicle brake, can optionally form a brake system in the vehicle.

According to an even further advantageous embodiment which relates to the combination of an electromechanical brake device and the hydraulic vehicle brake, wherein the brake piston is adjustable in the direction toward the brake disk by the electric brake motor as well as by the hydraulic brake pressure, the position of the brake piston for compensating the temperature influence is adjusted by a variation of the brake pressure. The adjustment of the position of the brake piston by way of modifying the hydraulic brake pressure takes place alternatively or additionally to the adjustment of the brake piston by way of the electric brake motor.

Further advantages and expedient embodiments are to be derived from the further claims, the description of the figures, and the drawings in which:

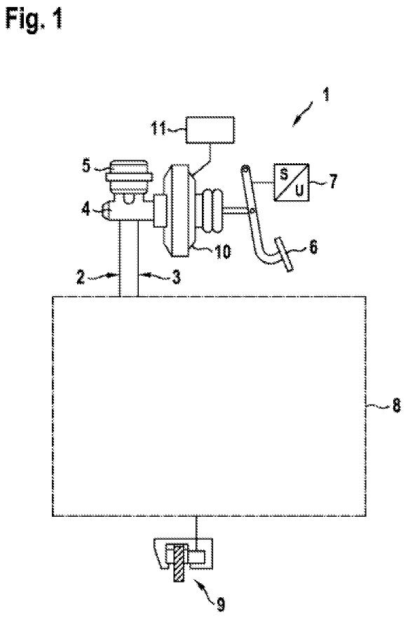

FIG. 1 shows a schematic illustration of a hydraulic vehicle brake, wherein the wheel brake installations of the vehicle brake are equipped with electromechanical brake devices having in each case one electric brake motor;

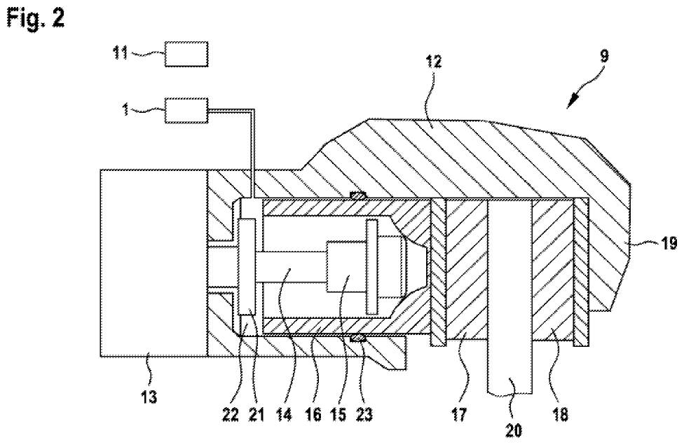

FIG. 2 shows a section through an electromechanical brake device having an electric brake motor; and

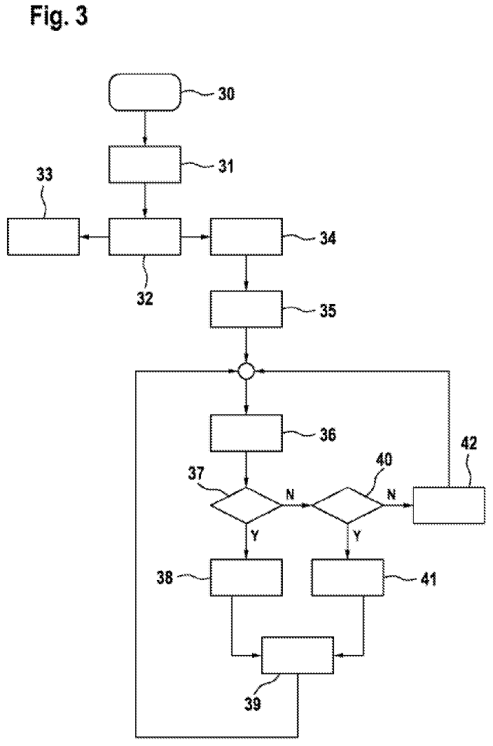

FIG. 3 shows a flow diagram with method steps for providing an electromechanical brake force as a function of temperature during an automated procedure for entering a parking space.

Identical components are provided with the same reference signs in the figures.

The brake system for a vehicle illustrated in FIG. 1 comprises a hydraulic dual-circuit vehicle brake 1 having a first hydraulic brake circuit 2 and a second hydraulic brake circuit 3 for supplying and actuating wheel brake installations 9 on each wheel of the vehicle with a hydraulically pressurized brake fluid. The two brake circuits 2, 3 are connected to a common master brake cylinder 4 which by way of a brake liquid reservoir 5 is supplied with brake fluid. The master brake cylinder piston in the master brake cylinder 4 is activated by the driver by way of the brake pedal 6; the pedal travel exerted by the driver is measured by way of the pedal travel sensor 7. A brake booster 10 (iBooster) which comprises an electric motor which by way of a transmission activates the master brake cylinder 4, for example, is situated between the brake pedal 6 and the master brake cylinder 4.

Additionally or alternatively to the iBooster, the hydraulic vehicle brake 1 can have an integrated electro-hydraulic brake unit having a plunger which is driven by an electric motor. The vehicle brake 1 is advantageously configured as a brake-by-wire system, wherein an activation of the brake pedal leads to a displacement of the hydraulic volume in a pedal travel simulator. The buildup of brake pressure takes place so as to correspond to the activation of the brake pedal by way of an activation of the plunger by an electric motor. In the event of a failure of the electro-hydraulic brake unit, cutout valves which connect the brake circuits to the master brake cylinder 4 are opened such that the driver when activating the brake pedal has a direct hydraulic access to the wheel brake installations 9.

The actuating movement of the brake pedal 6 measured by the pedal travel sensor 7 is transmitted as a sensor signal to a closed-loop and/or open-loop control unit 11, in which actuating signals for actuating the brake booster 10 are generated. The supply of the wheel brake installations 9 with brake fluid in each brake circuit 2, 3 takes place by different switch valves which, conjointly with further apparatuses, are part of brake hydraulics 8. A hydraulic pump which is a component part of an electronic stability program (ESP) is furthermore associated with the brake hydraulics 8.

The two hydraulic brake circuits 2 and 3 of the dual-circuit vehicle brake 1 are divided diagonally, for example, such that the first brake circuit 2 supplies the two wheel brake installations 9 on the left front wheel and on the right rear wheel with brake fluid, for example, and the second brake circuit 3 supplies the two wheel brake installations 9 on the right front wheel and on the left rear wheel with brake fluid. Alternatively, apportioning both hydraulic brake circuits 2 and 3 of the dual-circuit vehicle brake 1 to the wheel brake installations on the front axle and the wheel brake installations on the rear axle is also possible.

The wheel brake installation 9 which is disposed on a wheel on the rear axle of the vehicle is illustrated in detail in FIG. 2. The wheel brake installation 9 is part of the hydraulic vehicle brake 1 and is supplied with brake fluid 22 from a brake circuit 2, 3. The wheel brake installation 9 moreover has an electromechanical brake device which can be used as a holding brake for a immobilizing the vehicle when stopped but also for decelerating the vehicle in motion.

The electromechanical brake device comprises a brake caliper assembly 12 having a caliper 19 which straddles a brake disk 20. The brake device as an actuator has a DC electric motor as a brake motor 13, the rotor shaft of the latter driving in a rotating manner a spindle 14 on which a spindle nut 15 is mounted in a rotationally fixed manner. The spindle nut 15 is axially adjusted in the rotation of the spindle 14. The spindle nut 15 moves within a brake piston 16 which is a support of a brake lining 17 which by the brake piston 16 is pressed against the brake disk 20. A further brake lining 18 which is held so as to be locationally fixed on the caliper 19 is situated on the opposite side of the brake disk 20. The brake piston 16, on the external side thereof, by way of an encircling annular seal 23 is sealed in a pressure-tight manner in relation to the receiving housing.

The spindle nut 15 within the brake piston 16 can move axially forward in the direction toward the brake disk 20 in the case of a rotational movement of the spindle 14, or, respectively, can move axially rearward, until it reaches a stop 21, in the case of an opposite rotational movement of the spindle 14. In order for a clamping force to be generated, the spindle nut 15 impinges the internal end side of the brake piston 16, on account of which the brake piston 16, which is mounted so as to be axially displaceable in the brake device, by way of the brake lining 17 is pressed against the facing end face of the brake disk 20.

For the hydraulic brake force, the hydraulic pressure of the brake fluid 22 from the hydraulic vehicle brake 1 acts on the brake piston 16. The hydraulic pressure can also be effective in facilitating manner when activating the electromechanical brake device in the stopped vehicle such that the total brake force is composed of the portion provided by the electric motor and the hydraulic portion. In order to generate a brake force for carrying out a brake procedure when the vehicle is in motion, either the hydraulic vehicle brake alone, or the hydraulic vehicle brake as well as the electromechanical brake device, or the electromechanical brake device alone is/are active. The actuating signals for actuating the adjustable components of the hydraulic vehicle brake 1 as well as of the electromechanical wheel brake installation 9 are generated in the closed-loop or open-loop control unit 11, respectively.

The wheel brake installation 9, which is illustrated in FIG. 2 and is additionally equipped with the electromechanical brake device having the brake motor 13, is preferably situated on the rear axle of the vehicle. The electric brake motors 13 in the two wheel brake installations 9 on the rear axle can be actuated in a mutually independent manner.

A flow diagram with method steps for providing an electromechanical brake force as a function of temperature during an automated procedure for entering a parking space is illustrated in FIG. 3. After the method has started in step 30, the vehicle is stopped in the following step 31, for example at a transfer station where the driver exits the vehicle and the vehicle, starting from the transfer station, is parked in an automated manner. The automated parking procedure begins in the next step 32, for example in response to a command of the driver, of a third person, or in an automated manner. A braking force in the electromechanical brake device is subsequently pre-adjusted in that the electric brake motor is activated and the brake piston is adjusted in the direction toward the brake disk until the brake lining on the brake piston contacts the brake disk. The brake force is set to a level such that the procedure of entering the parking space, which is carried out at a low speed, can be carried out despite the applied brake force. The brake lining bearing on the brake disk offers the advantage of a short reaction time in the event that the vehicle is to be decelerated, optionally until stopped, by way of a further activation of the electric brake motor.

The further method steps 34 to 42 are carried out continually during the procedure of entering the parking space. This herein is a correction of the permanently applied brake force which has been pre-adjusted in step 33, in order to compensate for variations in the length in the components of the brake installation due to temperature.

First, the current brake temperature, for example the brake disk temperature, is estimated in a step 34. The estimation takes place by evaluating state variables or operating variables of the vehicle brake or of the vehicle, for example by evaluating the number of brake activations in a specific period of time. Additionally or alternatively, the brake temperature in step 34 can also be determined with the aid of a temperature sensor.

It is also possible for the estimation/determination of the brake temperature to be carried out already during the usual driving operation, thus even prior to the start of the automated procedure for entering the parking space.

In the next step 35, the vehicle is set in motion so as to carry out the procedure of entering the parking space. The brake force pre-adjusted in step 33 continues to act during the movement of the vehicle, this by virtue of friction potentially leading to an increase in temperature.

A fresh determination of the brake temperature by estimation or measurement takes place in the next step 36. Monitoring as to whether the brake temperature has increased by a minimum temperature difference, for example has increased by at least 20°, takes place in the next step 37. In the affirmative, the Yes branch (“Y”) is continued to step 38, and the electric brake motor is actuated in the direction of releasing the brake force. The actuation takes place in a force-controlled or displacement-controlled manner such that the brake force remains so as to be at least approximately constant at the level adjusted in step 33. The expansion of components of the brake device due to temperature is taken into account in step 38.

The current brake temperature which has been determined in step 36 is subsequently stored in step 39, and step 36 is thereafter returned to in order for the method to be again implemented at periodic intervals.

If the monitoring in step 37 reveals that there is no temperature increase by a minimum temperature difference, the No branch (“N”) is followed to step 40 in which monitoring whether the brake temperature has dropped by a minimum temperature difference of, for example, 20° is carried out. In the affirmative, the Yes branch is followed so as to advance to step 41, and the electric brake motor is actuated in the direction of increasing the brake force. The contraction of the components of the brake device due to temperature is taken into account herewith. Step 39 is subsequently advanced to, in which step the current brake temperature is stored, whereupon the entire method from step 36 on is again implemented at periodic intervals.

If the monitoring in step 40 reveals that the brake temperature has not dropped by the minimum temperature difference, the brake temperature is thus within a permissible temperature bandwidth. The No branch is thereafter followed so as to advance to step 42 according to which no variation in the position of the electric brake motor is carried out. The method from step 36 on is subsequently again implemented at periodic intervals.

1. A method for actuating an electromechanical brake device in a vehicle, comprising:
generating a brake force with an electric brake motor that impinges a brake piston against a brake disk; and,
adjusting a position of the brake piston, when the vehicle is in motion, as a function of a brake temperature.

2. The method as claimed in claim 1, wherein, when the vehicle is in motion, the position of the brake piston is adjusted such that a brake lining which is held on the brake piston is spaced apart from the brake disk.

3. The method as claimed in claim 1, wherein the position of the brake piston is adjusted as a function of temperature such that a brake lining which is held on the brake piston bears on the brake disk to generate a brake force.

4. The method as claimed in claim 3, wherein the position of the brake piston is adjusted as a function of temperature such that the brake force remains at least approximately constant.

5. The method as claimed in claim 1, wherein the position of the brake piston is adjusted as a function of temperature in a displacement-controlled manner.

6. The method as claimed in claim 1, wherein the brake piston is also impinged by a brake pressure of a hydraulic vehicle brake, and wherein the position of the brake piston is adjusted by varying the brake pressure.

7. The method as claimed in claim 1, wherein the brake temperature is determined from state variables or operating variables of the brake device, the vehicle, or a further apparatus of the vehicle.

8. The method as claimed in claim 1, further comprising measuring the brake temperature.

9. The method as claimed in claim 1, wherein the method is carried out below a speed limit value.

10. The method as claimed in claim 1, wherein the method is carried out in a procedure for entering or leaving a parking space, the procedure carried out in an autonomous manner.

11. A closed-loop and/or open-loop control unit for actuating adjustable components of an electromechanical brake device in a vehicle, the control unit configured to:
generate a brake force with an electric brake motor that impinges a brake piston against a brake disk, and
adjust a position of the brake piston, when the vehicle is in motion, as a function of a brake temperature.

12. An electromechanical brake device for a vehicle, comprising:
an electric brake motor which adjusts a brake piston in a direction toward a brake disk; and
a closed-loop and/or open-loop control unit configured to actuate adjustable components of the electromechanical brake device, the control unit configured to:
generate a brake force with the electric brake motor that impinges the brake piston against the brake disk, and
adjust a position of the brake piston, when the vehicle is in motion, as a function of a brake temperature.

13. The method as claimed in claim 9, wherein the speed limit value is 30 km/h.
